(19) United States
(12) Patent Application Publication
(10) Pub. No.: US 2016/0141824 A1
(43) Pub. Date: May 19, 2016

(54) GAS LASER APPARATUS CAPABLE OF INSPECTING AIR-TIGHTNESS OF LASER GAS SUPPLY PIPE

(71) Applicant: FANUC CORPORATION, Minamitsuru-gun (JP)

(72) Inventors: Munekazu MATSUDA, Minamitsuru-gun (JP); Tetsuhisa TAKAZANE, Minamitsuru-gun (JP)

(73) Assignee: FANUC CORPORATION, Minamitsuru-gun (JP)

(21) Appl. No.: 14/942,063

(22) Filed: Nov. 16, 2015

(30) Foreign Application Priority Data
Nov. 17, 2014 (JP) 2014-233143

(51) Int. Cl. H01S 3/036; H01S 3/00

(52) U.S. Cl. CPC H01S 3/036; H01S 3/0014

(57) ABSTRACT

A gas laser apparatus includes a supply pipe forming a passage of laser gas supplied to a gas container from outside, a pressure sensor that detects pressure in the supply pipe, a supply control valve that controls an amount of the laser gas supplied to the gas container, and a controller that controls opening and closing of the supply control valve. The controller includes a pressure acquisition unit that acquires a pressure value in the supply pipe, a pressure change calculation unit that calculates a pressure change in the supply pipe based on the pressure values acquired by the pressure acquisition unit a plurality of times in a predetermined period of time while the supply pipe is sealed, and an air-tightness determination unit that determines an air-tightness level of the supply pipe on the basis of the pressure change calculated by the pressure change calculation unit.

### BACKGROUND OF THE INVENTION

1. Field of the Invention

The present invention relates to a gas laser apparatus including a gas laser oscillator that oscillates laser using laser gas as medium.

2. Description of the Related Art

A gas laser oscillator generates a discharge inside a gas container to excite laser gas, thereby oscillating a laser. The laser gas is supplied from the outside of the gas laser oscillator into the gas container through a supply pipe. It is known that the laser output of such a gas laser oscillator may decline when moisture intrudes in the laser gas, or a component of the laser gas leaks from the gas container or the supply pipe. Accordingly, it is desirable to inspect the air-tightness of the gas container and the supply pipe, in order to ensure stable laser output.

In general, the air-tightness of a gas container is checked in a vacuum state after the gas is discharged from the gas container. For example, Japanese Laid-open Patent Publication No. 2002-319724 discloses a technique of automatically inspecting the air-tightness of the gas container by measuring the pressure inside the tightly sealed gas container at predetermined time intervals after the gas is discharged from the gas container.

In addition, a known method for inspecting air-tightness of a laser gas supply pipe includes tightly sealing the internal space of the supply pipe after pressurizing the supply pipe, and detecting pressure drop in the supply pipe. Generally, an operator reads the value indicated by a pressure gauge attached to the regulator of the laser gas supply unit, in order to calculate the pressure drop in the supply pipe.

Japanese Laid-open Patent Publication No. 4-80979 and International Publication No. 2013/171951 discloses discharging a gas in the supply pipe to the outside of the gas laser oscillator temporarily, in order to prevent the laser output from being unstable due to leakage of a laser gas component or intrusion of impurities while the gas laser oscillator is not in operation.

The air-tight design is different depending on whether the device is used in a vacuum state (negative pressure) or in a pressurized state, and therefore the method for inspecting air-tightness of the gas container described in Japanese Laid-open Patent Publication No. 2002-319724 is not applicable to the supply pipe used in a pressurized state.

According to the inspection method in which the pressure drop in the supply pipe is determined by reading a value of the pressure gauge of the regulator, it is necessary for an operator to visually measure the pressure value to calculate the pressure drop, and therefore the work efficiency is low. In addition, the detection resolution of a Bourdon tube pressure gauge, which is commonly used in a regulator, is approximately 10 kPa, and therefore it takes a long time, for example eight hours, before a detectable pressure drop of 10 kPa takes place.

Accordingly, there is a need for a gas laser apparatus that allows the air-tightness inspection of the laser gas supply pipe to be automatically performed in a short time.

### SUMMARY OF THE INVENTION

According to a first aspect of the present invention, there is provided a gas laser apparatus comprising a gas laser oscillator configured to oscillate laser utilizing laser gas as medium, the gas laser apparatus comprising: a gas container configured to store the laser gas; a supply pipe forming a supply passage of the laser gas supplied to the gas container from an outside of the gas laser oscillator; a pressure sensor configured to detect pressure in the supply pipe;

a supply control valve configured to control an amount of the laser gas supplied to the gas container through the supply pipe; and a controller configured to control an opening and closing of the supply control valve, wherein the controller comprises: a pressure acquisition unit configured to acquire a pressure value in the supply pipe through the pressure sensor; a pressure change calculation unit configured to calculate a pressure change in the supply pipe, on a basis of pressure values acquired by the pressure acquisition unit a plurality of times in a predetermined period of time, while the supply control valve is closed to tightly seal the supply pipe; and an air-tightness determination unit configured to determine an air-tightness level of the supply pipe on a basis of the pressure change calculated by the pressure change calculation unit.

According to a second aspect of the present invention, in the gas laser apparatus according to the first aspect, the pressure change calculation unit is configured to calculate the pressure change on a basis of a difference between at least one pressure value acquired first in the predetermined period of time and at least one pressure value acquired last in the predetermined period of time.

According to a third aspect of the present invention, in the gas laser apparatus according to the first aspect, the pressure change calculation unit is configured to calculate the pressure change through regression analysis of the plurality of pressure values acquired.

According to a fourth aspect of the present invention, in the gas laser apparatus according to any one of the first to third aspects, the controller further comprises: a display unit configured to display the pressure value acquired by the pressure acquisition unit and the pressure change calculated by the pressure change calculation unit; and a warning notification unit configured to notify a warning when the pressure change calculated by the pressure change calculation unit exceeds a predetermined threshold.

According to a fifth aspect of the present invention, the gas laser apparatus according to any one of the first to fourth aspects further comprises a discharge control valve configured to discharge the laser gas through the supply pipe to the outside of the gas laser oscillator, without allowing the laser gas to pass through the gas container, wherein the controller further comprises a discharge valve control unit configured to maintain the discharge control valve open for a predetermined period of time when the pressure change calculated by the pressure change calculation unit exceeds a predetermined threshold.

According to a sixth aspect of the present invention, in the gas laser apparatus according to any one of the first to fifth aspects, the controller further comprises a storage unit configured to store, without power supply from outside, the pressure value acquired by the pressure acquisition unit and a time point at which the pressure value is acquired, and the pressure change calculation unit is configured to calculate the pressure change on a basis of the pressure value and the time point stored in the storage unit, when the power supply from the outside is resumed.

These and other objects, features and advantages of the present invention will become more apparent in light of the detailed description of exemplary embodiments thereof as illustrated in the drawings.

### BRIEF DESCRIPTION OF THE DRAWINGS

FIG. 1 is a diagram showing an exemplary configuration of a gas laser apparatus according to one embodiment of the present invention;

FIG. 2 is a functional block diagram of a controller of the gas laser apparatus according to the embodiment;

FIG. 3 is a graph for explaining pressure changes calculated according to the embodiment;

FIG. 4 is a graph for explaining pressure changes calculated according to a variation of the embodiment represented in FIG. 3;

FIG. 5 is a graph for explaining pressure changes calculated according to another embodiment;

FIG. 6 is a graph for explaining pressure changes calculated according to still another embodiment;

FIG. 7 is a functional block diagram of a controller of a gas laser apparatus according to another embodiment;

FIG. 8 is a functional block diagram of a controller of a gas laser apparatus according to still another embodiment; and

FIG. 9 is a flowchart showing an air-tightness inspection process performed by a controller according to one embodiment.

### DETAILED DESCRIPTION

Hereafter, embodiments of the present invention will be described with reference to the accompanying drawings. In the drawings, the constituent elements may be illustrated in different scales for the sake of clarity, and the same or corresponding constituent elements will be indicated by the same reference numeral.

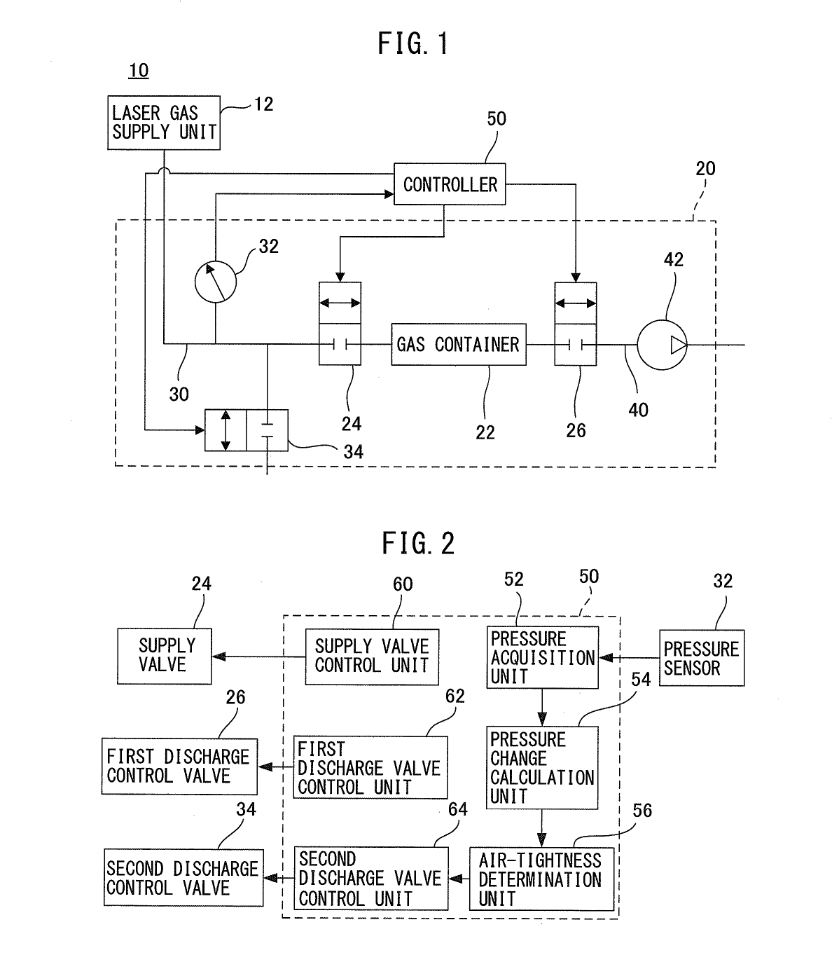

FIG. 1 is a diagram showing an exemplary configuration of a gas laser apparatus according to one embodiment of the present invention. A gas laser apparatus 10 includes a gas laser oscillator 20 provided with an optical resonator (not illustrated), a laser gas supply unit 12 that supplies a laser gas to a gas container 22 of the gas laser oscillator 20, and a controller 50 that controls an amount of laser gas supplied to or discharged from the gas container 22. The gas laser apparatus 10 may be used in a laser processing apparatus, for example, to cut sheet metal.

The laser gas supply unit 12 includes, although not illustrated in details, a cylinder that stores the laser gas, and a regulator that adjusts the pressure of the laser gas supplied to the gas laser oscillator 20. The gas laser oscillator 20 and the laser gas supply unit 12 are connected to each other via a supply pipe 30. For example, the laser gas of 0 kPa to 1000 kPa in terms of gauge pressure is supplied by the laser gas supply unit 12 to the gas container 22 through the supply pipe 30.

The gas laser oscillator 20 includes the gas container 22 through which the laser gas circulates, a supply control valve 24 that controls an amount of laser gas supplied to the gas container 22 through the supply pipe 30, and first discharge control valve 26 that controls an amount of laser gas discharged from the gas container 22.

The gas container 22 contains the laser gas of −100 kPa to −70 kPa in terms of gauge pressure. The gas laser oscillator 20 supplies energy to a discharge tube (not illustrated) inside the gas container 22 to cause discharge, and excites the laser gas, thereby oscillating the laser. The laser gas is a mixed gas containing, for example, carbon dioxide, nitrogen, and helium in a predetermined composition ratio. The configuration and function of the gas laser oscillator 20 is widely known, and hence a detailed description thereof will be omitted herein.

A discharge pipe 40 is connected to the first discharge control valve 26, so that the gas in the gas container 22 can be discharged to the outside of the gas laser oscillator 20. A discharge pump 42 is provided downstream of the first discharge control valve 26 in relation to the gas flow discharged from the gas container 22. For example, if the laser gas in the gas container 22 deteriorates, the first discharge control valve 26 is opened and the discharge pump 42 is activated so as to discharge the gas in the gas container 22 to the outside through the discharge pipe 40.

The supply pipe 30 includes a pressure sensor 32 and a second discharge control valve 34. The pressure sensor 32 is configured to detect the pressure of the laser gas supplied through the supply pipe 30. The pressure sensor 32 is operated with electric power supplied from the outside, and has a detection resolution of, for example, approximately 1 kPa or smaller. The measurement result of the pressure sensor 32 is inputted to the controller 50 in the form of a voltage or current, for example. The second discharge control valve 34 is configured to control the amount of laser gas discharged to the outside of the gas laser oscillator 20 without being supplied to the gas container 22.

In this embodiment, the opening and closing of the supply control valve 24, the first discharge control valve 26, and the second discharge control valve 34 are controlled by the controller 50. The controller 50 is a digital computer including a CPU, a RAM, a ROM, and an interface for transmitting and receiving data and signals to and from an external device such as a display device and an input device. The controller 50 may also be configured to control a shutter that blocks or transmits a laser discharged from the gas laser oscillator 20.

The supply pipe 30 is formed of metal or resin. Generally resin pipes are employed because of the convenience in the installation. However, when the supply pipe made of resin is employed, moisture or molecules having a low molecular weight such as helium contained in the laser gas may permeate through the supply pipe. While the gas laser oscillator 20 is in operation, the change in composition of the laser gas is negligible. However, when the gas laser oscillator 20 is reactivated after a stoppage of a long time, for example 8 hours or more, the composition ratio of the laser gas in the supply pipe 30 may change to a non-negligible level unless the air-tightness of the supply pipe 30 is sufficient. When the laser gas whose composition ratio has been changed in the supply pipe 30 is supplied to the gas container 22, part of the laser may be absorbed by impurities, or the laser oscillation efficiency may be degraded, resulting in declined laser output. Therefore, the controller 50 of the gas laser apparatus 10 according to this embodiment is configured to automatically inspect the air-tightness of the supply pipe 30.

FIG. 2 is a functional block diagram of the controller 50. The controller 50 includes a pressure acquisition unit 52, a pressure change calculation unit 54, an air-tightness determination unit 56, a supply valve control unit 60, a first discharge valve control unit 62, and a second discharge valve control unit 64.

The pressure acquisition unit 52 acquires the pressure value of the laser gas in the supply pipe 30 from the measurement value of the pressure sensor 32 provided in the supply pipe 30. The pressure value acquired by the pressure acquisition unit 52 is inputted to the pressure change calculation unit 54. The controller 50 is configured to measure the time point at which the pressure acquisition unit 52 acquires the pressure value.

The pressure change calculation unit 54 calculates a pressure change in the supply pipe 30 in a predetermined period of time, on the basis of the information of the pressure value acquired by the pressure acquisition unit 52 and the time point at which the pressure value is acquired. Details of the calculation method of the pressure change will be described below. The pressure change calculation unit 54 may be configured to calculate the ratio of the pressure change amount with respect to the time, or the absolute value of the pressure change amount.

The air-tightness determination unit 56 determines the level of the air-tightness of the supply pipe 30 by comparing the pressure change calculated by the pressure change calculation unit 54 with a predetermined threshold. When the pressure change exceeds the threshold, the air-tightness determination unit 56 determines that the air-tightness of the supply pipe 30 is insufficient. For example, the air-tightness determination unit 56 determines that the air-tightness of the supply pipe 30 is insufficient when a pressure drop of 5% or more has taken place within 8 hours. When the pressure in the supply pipe 30 is 200 kPa in terms of gauge pressure, the air-tightness is determined to be insufficient when a pressure drop of 10 kPa or more takes place within 8 hours.

The supply valve control unit 60 controls the opening and closing of the supply control valve 24 of the gas laser apparatus 10. The supply valve control unit 60 is configured to close the supply control valve 24 when the air-tightness inspection of the supply pipe 30 is performed.

The first discharge valve control unit 62 controls the opening and closing of the first discharge control valve 26 of the gas laser apparatus 10. In order to inspect the air-tightness of the gas container 22 according to a known method, the first discharge valve control unit 62 opens the first discharge control valve 26 once to render gas container 22 in a vacuum state, and thereafter closes the first discharge control valve 26 to tightly seal the gas container 22.

The second discharge valve control unit 64 controls the opening and closing of the second discharge control valve 34 provided in the supply pipe 30. The second discharge valve control unit 64 is configured to open the second discharge control valve 34 and discharge the laser gas with a changed composition ratio in the supply pipe 30, when the gas laser oscillator 20 is reactivated after a stoppage of a long time. The second discharge valve control unit 64 may also be configured such that, when the air-tightness determination unit 56 determines that the air-tightness of the supply pipe 30 is insufficient, the second discharge valve control unit 64 maintains the second discharge control valve 34 open for a longer time than the case where the gas laser oscillator 20 is normally reactivated.

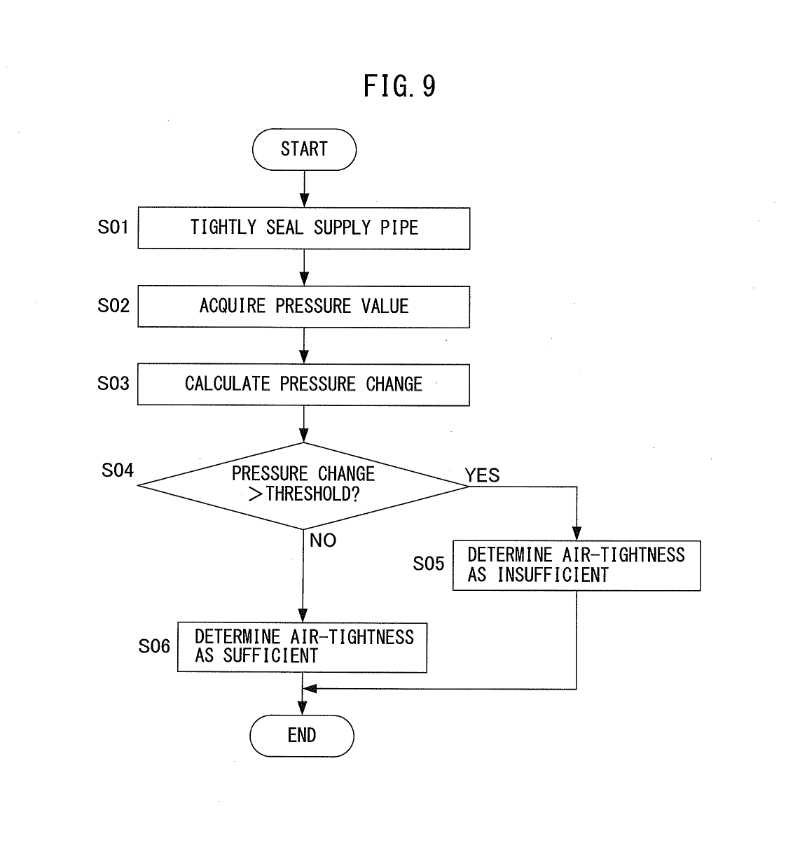

Referring to FIG. 9, the air-tightness inspection process of the supply pipe 30 according to one embodiment will be described. FIG. 9 is a flowchart showing the air-tightness inspection process performed by the controller 50. Generally, the air-tightness inspection process of the supply pipe 30 is performed during the maintenance work of the gas laser apparatus 10, or during the night when the gas laser oscillator 20 is temporarily stopped.

First, at step S01, a supply valve (not shown) of the laser gas supply unit 12, the supply control valve 24, and the second discharge control valve 34 are closed, to tightly seal the internal space of the supply pipe 30. The supply control valve 24 and the second discharge control valve 34 are closed by the controller 50. On the other hand, the supply valve of the laser gas supply unit 12 is manually closed by an operator.

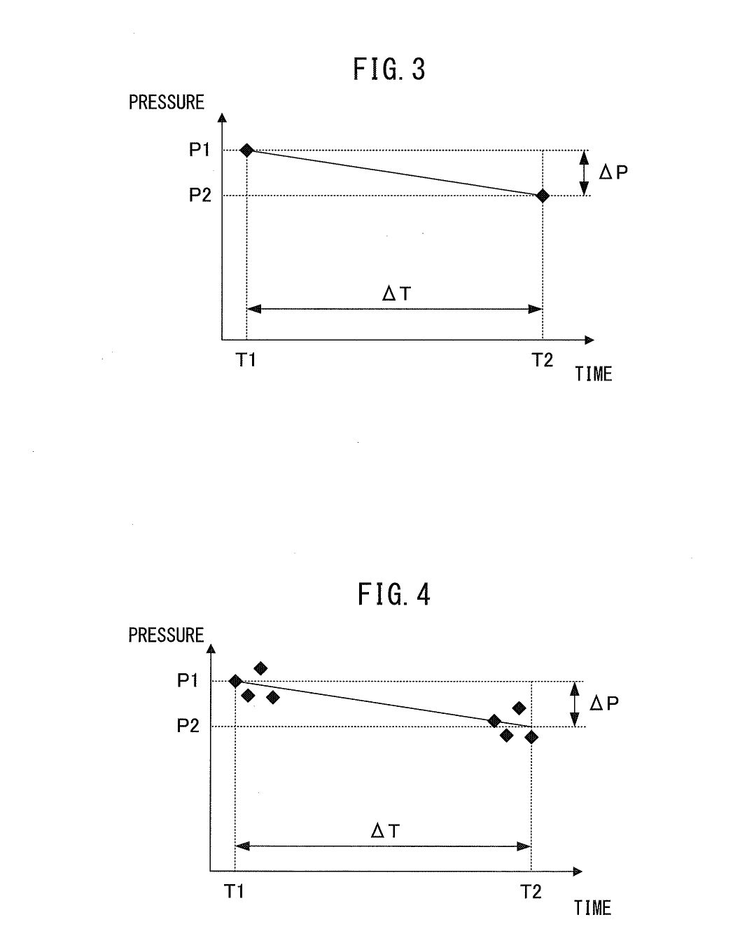

At step S02, the pressure acquisition unit 52 acquires a pressure value in the supply pipe 30 multiple times in a predetermined period of time, for example, each of the starting and ending points of the time period. For example, in the case where a pressure change during a period ΔT from a time point T1 to a time point T2 as illustrated in FIG. 3, the pressure acquisition unit 52 acquires a pressure P1 at the starting time point T1 and a pressure P2 at the ending time point T2, from the measurement value of the pressure sensor 32.

At step S03, the pressure change calculation unit 54 calculates a pressure change amount ΔP (i.e., P1−P2) in the time period ΔT as a pressure change. For example, the pressure change calculation unit 54 calculates a pressure change rate with respect to the time, in other words ΔP/ΔT as a pressure change. Alternatively, the pressure change calculation unit 54 may calculate the pressure change amount ΔP as a pressure change. Thus, as long as the pressure change calculated by the pressure change calculation unit 54 is useful for determining the air-tightness of the supply pipe 30, the calculation method of the pressure change is not specifically limited.

At step S04, the air-tightness determination unit 56 compares the pressure change calculated at step S03 with a predetermined threshold. When it is determined at step S04 that the pressure change in the supply pipe 30 exceeds the threshold, the process proceeds to step S05, where it is determined that the air-tightness of the supply pipe 30 is insufficient. When it is determined at step S04 that the pressure change in the supply pipe 30 is not greater than the threshold, the process proceeds to step S06, where it is determined that the air-tightness of the supply pipe 30 is sufficient.

When it is determined that the air-tightness of the supply pipe 30 is insufficient, a component of the supply pipe 30, such as a seal part, a valve, and a pipe are replaced or repaired as necessary. When it is difficult to replace or repair the component, the second discharge valve control unit 64 opens the second discharge control valve 34 to discharge the gas in the supply pipe 30 to the outside of the gas laser oscillator 20, for a longer time than when the gas laser oscillator 20 is normally reactivated. Then, fresh laser gas is supplied from the laser gas supply unit 12 to the supply pipe 30.

In the gas laser apparatus 10 according to this embodiment, the detection value of the pressure sensor 32 is acquired by the pressure acquisition unit 52 of the controller 50. This eliminates the need for an operator to read the measurement value of the pressure sensor 32, thereby allowing the air-tightness inspection to be automatically performed. In addition, since the pressure sensor 32 having a higher detection resolution than an ordinary pressure gauge attached to a regulator is employed, the air-tightness inspection of the supply pipe 30 can be performed in a shorter time than in the conventional inspections. For example, when the pressure sensor 32 has a detection resolution of 1 kPa, a pressure drop of the laser gas by 5% (10 kPa) within 8 hours from 200 kPa in terms of gauge pressure can be detected within 48 minutes.

A variation of the above-described embodiment will be described. According to this variation, the pressure acquisition unit 52 acquires a plurality of, e.g., four pressure values immediately after the starting time point T1 of the time period ΔT, as illustrated in FIG. 4. The pressure acquisition unit 52 also acquires a plurality of, e.g., four pressure values closest to the ending time point T2 of the time period ΔT. Then, the pressure change calculation unit 54 calculates a pressure change in the supply pipe 30 over the inspection period ΔT, on the basis of a difference between the average value of the four pressure values acquired immediately after the starting time point T1 and the average value of the four pressure values acquired immediately before the ending time point T2.

As illustrated in FIG. 4, the measurement value of the pressure sensor 32 may fluctuate. However, according to this variation, the pressure change is calculated on the basis of the average of the pressure values acquired at different time points, and therefore the result of the air-tightness inspection can be prevented from being affected by the fluctuation of the pressure value.

In another embodiment, the pressure acquisition unit 52 is configured to acquire the pressure value in the supply pipe 30 with the pressure sensor 32 a plurality of times after the starting time point T1. Then, the pressure change calculation unit 54 calculates a pressure change in the supply pipe 30 in an elapsed time period by using a technique of regression analysis of a group of pressure values acquired over a predetermined period of time.

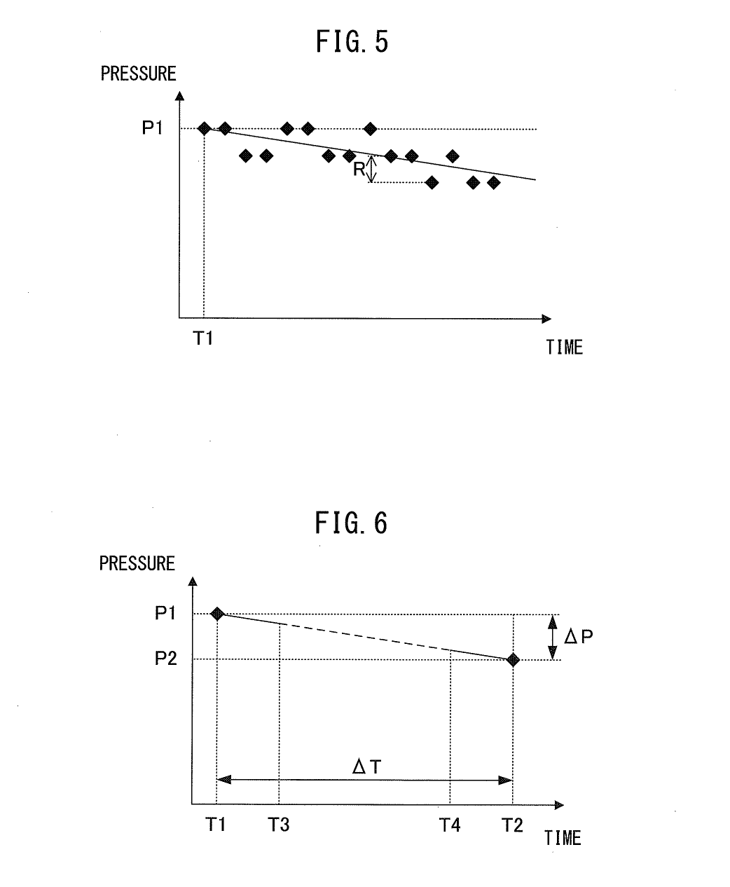

As illustrated in FIG. 5, the pressure values acquired by the pressure acquisition unit 52 may be discrete values depending on the detection resolution R of the pressure sensor 32. Accordingly, a pressure value acquired at a given time point may not always be accurate. In this embodiment, the pressure change amount (inclination of the graph of FIG. 5) with respect to time is calculated by using regression analysis based on the data group of the acquired pressure values, and therefore a highly reliable air-tightness inspection can be completed in a short time. For example, when the pressure change is calculated through regression analysis based on n pieces of pressure values, the accuracy of the calculation result can be improved by approximately 1/√n.

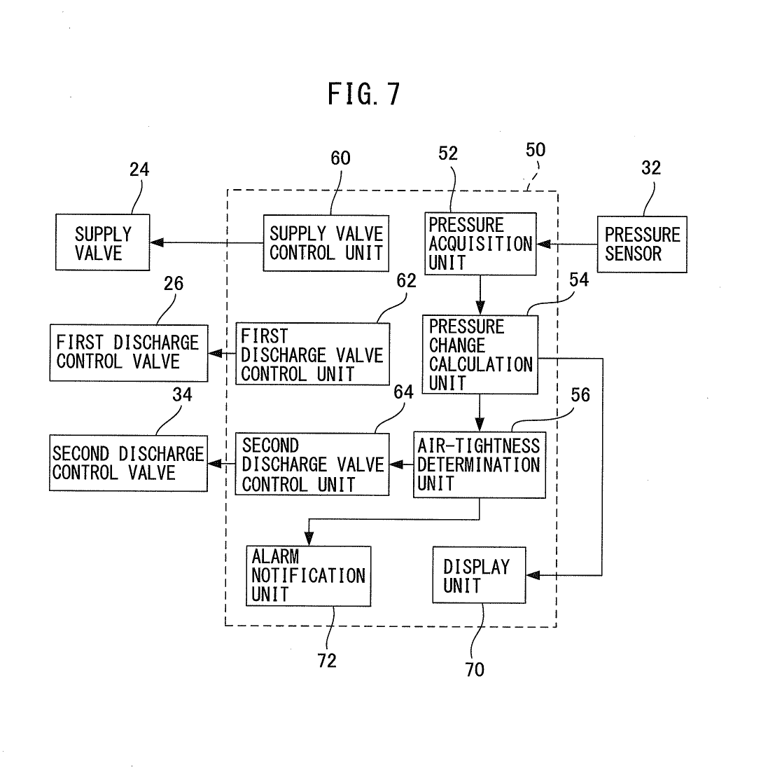

FIG. 7 is a functional block diagram of a controller 50 of the gas laser apparatus 10 according to another embodiment. In this embodiment, the controller 50 further includes a display unit 70 and a warning notification unit 72.

The display unit 70 displays a pressure value acquired by the pressure acquisition unit 52 or a pressure change calculated by the pressure change calculation unit 54, with a display device. The display device may be a device attached to the controller 50, or an external device connected to the controller 50.

The warning notification unit 72 notifies an operator of the result of the air-tightness inspection in a perceivable manner, such as by sound, light, or vibration, when the air-tightness determination unit 56 determines that the air-tightness of the supply pipe 30 is insufficient.

According to this embodiment, an operator can easily check the result of the air-tightness inspection of the supply pipe 30 displayed by the display unit 70. In addition, when it is determined that the air-tightness of the supply pipe 30 is insufficient, the warning notification unit 72 notifies the operator of the air-tightness inspection result. In response thereto, the operator can take necessary measures such as inspection of the supply pipe 30, and repair or replacement of a component.

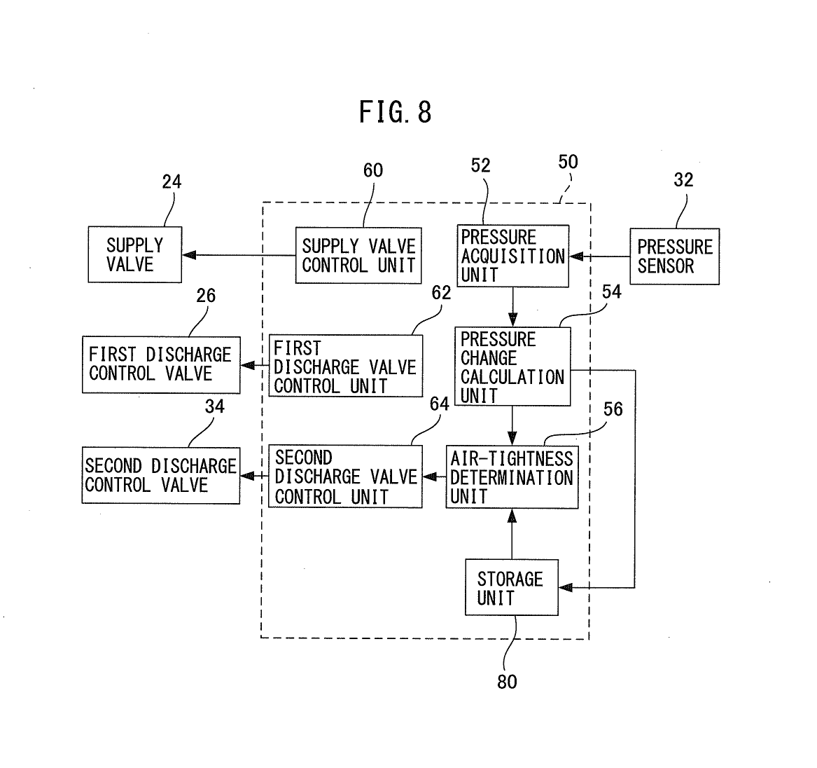

FIG. 8 is a functional block diagram of a controller 50 of the gas laser apparatus 10 according to still another embodiment. In this embodiment, the gas laser apparatus 10 is configured to continue with the air-tightness inspection of the supply pipe 30 without interruption, even when power supply from the outside is shut down. More specifically, the controller 50 further includes a storage unit 80 that stores, without power supply from the outside, the pressure value acquired by the pressure acquisition unit 52 and the time point at which the pressure value is acquired. The storage unit 80 stores the pressure value and the time point with power, for example, supplied from a standby power source incorporated in or connected to the controller 50.

In this embodiment, as illustrated in FIG. 6, even when the power supply from the outside is shut down from a time point T3 to a time point T4, the pressure change calculation unit 54 can calculate a pressure change on the basis of the information stored in the storage unit 80.

According to this embodiment, the air-tightness inspection can be continuously performed without interruption, even when the power supply to the gas laser apparatus 10 is temporarily shut down, for example, during the night time.

### EFFECT OF THE INVENTION

In the gas laser oscillator according to the present invention, the air-tightness of the supply pipe can be automatically inspected by measuring the pressure drop in the supply pipe using the pressure sensor, with the supply control valve closed.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. A gas laser apparatus comprising a gas laser oscillator configured to oscillate a laser utilizing laser gas as a medium, the gas laser apparatus comprising:
a gas container configured to store the laser gas;
a supply pipe forming a supply passage of the laser gas supplied to the gas container from an outside of the gas laser oscillator;
a pressure sensor configured to detect pressure in the supply pipe;
a supply control valve configured to control an amount of the laser gas supplied to the gas container through the supply pipe; and
a controller configured to control an opening and closing of the supply control valve,
wherein the controller comprises:
a pressure acquisition unit configured to acquire a pressure value in the supply pipe through the pressure sensor;
a pressure change calculation unit configured to calculate a pressure change in the supply pipe, on a basis of pressure values acquired by the pressure acquisition unit a plurality of times in a predetermined period of time, while the supply control valve is closed to tightly seal the supply pipe; and
an air-tightness determination unit configured to determine an air-tightness level of the supply pipe on a basis of the pressure change calculated by the pressure change calculation unit.

2. The gas laser apparatus according to claim 1, wherein the pressure change calculation unit is configured to calculate the pressure change on a basis of a difference between at least one pressure value acquired first in the predetermined period of time and at least one pressure value acquired last in the predetermined period of time.

3. The gas laser apparatus according to claim 1, wherein the pressure change calculation unit is configured to calculate the pressure change through regression analysis of the plurality of pressure values acquired.

4. The gas laser apparatus according to claim 1, wherein the controller further comprises:
a display unit configured to display the pressure value acquired by the pressure acquisition unit and the pressure change calculated by the pressure change calculation unit; and
a warning notification unit configured to notify a warning when the pressure change calculated by the pressure change calculation unit exceeds a predetermined threshold.

5. The gas laser apparatus according to claim 1, further comprising a discharge control valve configured to discharge the laser gas through the supply pipe to the outside of the gas laser oscillator, without allowing the laser gas to pass through the gas container,
wherein the controller further comprises a discharge valve control unit configured to maintain the discharge control valve open for a predetermined period of time when the pressure change calculated by the pressure change calculation unit exceeds a predetermined threshold.

6. The gas laser apparatus according to claim 1, wherein the controller further comprises a storage unit configured to store, without power supply from outside, the pressure value acquired by the pressure acquisition unit and a time point at which the pressure value is acquired, and
wherein the pressure change calculation unit is configured to calculate the pressure change on a basis of the pressure value and the time point stored in the storage unit, when the power supply from the outside is resumed.
